(19) United States
(12) Patent Application Publication
(10) Pub. No.: US 2007/0135140 A1
(43) Pub. Date: Jun. 14, 2007

(54) System and method for mobile school trip guard

(75) Inventor: Timo P. Tervo, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/299,844

(22) Filed: Dec. 12, 2005

(51) Int. Cl. H04Q 7/20

(52) U.S. Cl. 455/456.6

(57) ABSTRACT

A mobile terminal capable of tracking a position of the mobile terminal between a first location and a second location includes a memory, a controller and a positioning sensor. The memory stores executable instructions and route parameters between the first and second locations. The controller controls operation of the mobile terminal and executes the executable instructions. The positioning sensor determines position data of the mobile terminal. The controller executes instructions for tracking the mobile terminal position data relative to the route parameters and for directing transmission of a message to another device in response to the tracked position of the mobile terminal differing from the route parameters by a specified amount.

### FIELD OF THE INVENTION

Embodiments of the present invention relate generally to wireless technology and, more particularly, relate to enabling a mobile terminal to track an individual for safety purposes and report an unsafe condition.

### BACKGROUND OF THE INVENTION

The modem communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Such increased ease of information transfer and convenience to users has recently been accompanied by an increased ability to provide mobile communications at a relatively low cost. Accordingly, mobile communication devices are becoming ubiquitous in the modem world to the extent that it is no longer uncommon for even school aged children to possess such devices. With the rapid expansion of mobile communications technology, there has been a related rapid expansion in those services that are demanded and provided via mobile communication devices.

One area in which services have recently expanded is that of location monitoring. Recently, mobile communication devices such as cellular phones have been employed to provide location monitoring services. Location monitoring services have been developed in the form of applications that run on cellular phones, which may track and report the movement of a cellular phone. Such applications have been implemented with various location sensing devices and for numerous functions. However, it is currently common for increased functionality to necessarily result in increased cost to the user.

Thus, in the context of mobile communication devices employing location monitoring equipment, a need exists for providing a highly functional, yet relatively inexpensive application that is capable of providing location monitoring, for example, for children or youths traveling to or from predetermined locations such as schools. Furthermore, it is desirable that location monitoring be provided without a need to install expensive network support equipment.

### BRIEF SUMMARY OF THE INVENTION

A system, method, apparatus and computer program product are therefore provided which allow a mobile terminal to track its own current position and compare the current position to a predefined route that is stored at the mobile terminal. Responsive to the comparison, the mobile terminal is configured to send a message to another device, such as a third party device, if the current position differs from the predefined route by a selected amount. Furthermore, a time limit for the mobile terminal to travel from a first location, such as a start point, to a second location, such as a destination point, is also utilized and the message to the third party device is sent if the time limit is exceeded. Accordingly, safety may be relatively inexpensively provided for a carrier of the mobile terminal traveling along the predefined route since the functionality for tracking the mobile terminal is entirely contained within the mobile terminal.

According to an exemplary embodiment, a mobile terminal capable of tracking a position of the mobile terminal between a first location and a second location is provided. The mobile terminal includes a memory, a controller and a positioning sensor. The memory stores executable instructions and route parameters between the first and second locations. The controller controls operation of the mobile terminal and executes the executable instructions. The positioning sensor determines position data of the mobile terminal. The controller executes instructions for tracking the mobile terminal position data relative to the route parameters and for directing transmission of a message to another device in response to the tracked position of the mobile terminal differing from the route parameters by a specified amount.

According to an exemplary embodiment, a method for tracking a position of a mobile terminal between a first location and a second location is provided. The method includes initiating a tracking sequence to track the mobile terminal, receiving position information of the mobile terminal, and determining, responsive to the position information, at least one of whether the mobile terminal is within a specified distance of the predefined route and whether the mobile terminal reaches the second location within an allotted time.

According to an exemplary embodiment, a computer program product for tracking a position of a mobile terminal between a first location and a second location is provided. The computer program product includes first, second and third executable portions. The first executable portion is for initiating a tracking sequence to track the mobile terminal. The second executable portion is for receiving position information of the mobile terminal. The third executable portion is for determining, responsive to the position information, at least one of whether the mobile terminal is within a specified distance of the predefined route and whether the mobile terminal reaches the second location within an allotted time.

According to an exemplary embodiment, a system for tracking a position of a mobile terminal between a first location and a second location is provided. The system includes a network, a mobile terminal and a device. The mobile terminal is capable of wireless communication with the network. The mobile terminal is configured to store route parameters between the first and second locations and track a position of the mobile terminal relative to the route parameters. The device is capable of communication with the network. The mobile terminal is configured to transmit a message to the device in response to the tracked position of the mobile terminal differing from the route parameters by a specified amount.

Embodiments of the invention provide a system, method, apparatus and computer program product for tracking a position of a mobile terminal which may advantageously be utilized as safety equipment for children or youths traveling, for example, from home to school. As a result, a relatively low cost application may be provided with robust capability.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a block diagram according to an exemplary method of tracking a mobile terminal between a start point and a destination point; and

FIG. 4 is a block diagram according to another exemplary method of tracking a mobile terminal between a start point and a destination point.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

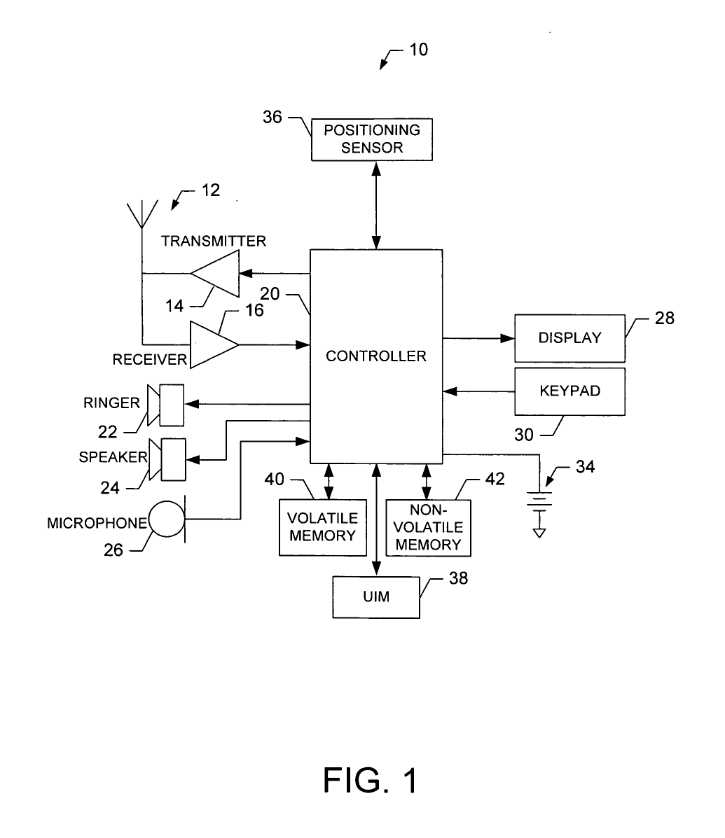

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, laptop computers and other types of voice and text communications systems, can readily employ the present invention. Moreover, the method of the present invention will be primarily described in conjunction with mobile communications applications. But the method of the present invention can be utilized in conjunction with a variety of other applications, both in the mobile communications industries and outside of the mobile communications industries. In addition, while several embodiments of the method of the present invention are performed or used by a mobile terminal 10, the method may be employed by other than a mobile terminal.

The mobile terminal 10 includes an antenna 12 in operable communication with a transmitter 14 and a receiver 16. The mobile terminal 10 further includes a controller 20 that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. More particularly, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal IO to transmit and receive Web content, such as location-based content, according to a Wireless Application Protocol (WAP), for example. Also, for example, the controller 20 may be capable of operating a software application capable of creating an authorization for delivery of location information regarding the mobile terminal 10, in accordance with embodiments of the present invention (described below).

The mobile terminal 10 also comprises a user interface including a conventional earphone or speaker 22, a ringer 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point.

The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identify or cell id information, with which the mobile terminal 10 is in communication. In conjunction with the positioning sensor 36, the cell id information may be used to more accurately determine a location of the mobile terminal 10.

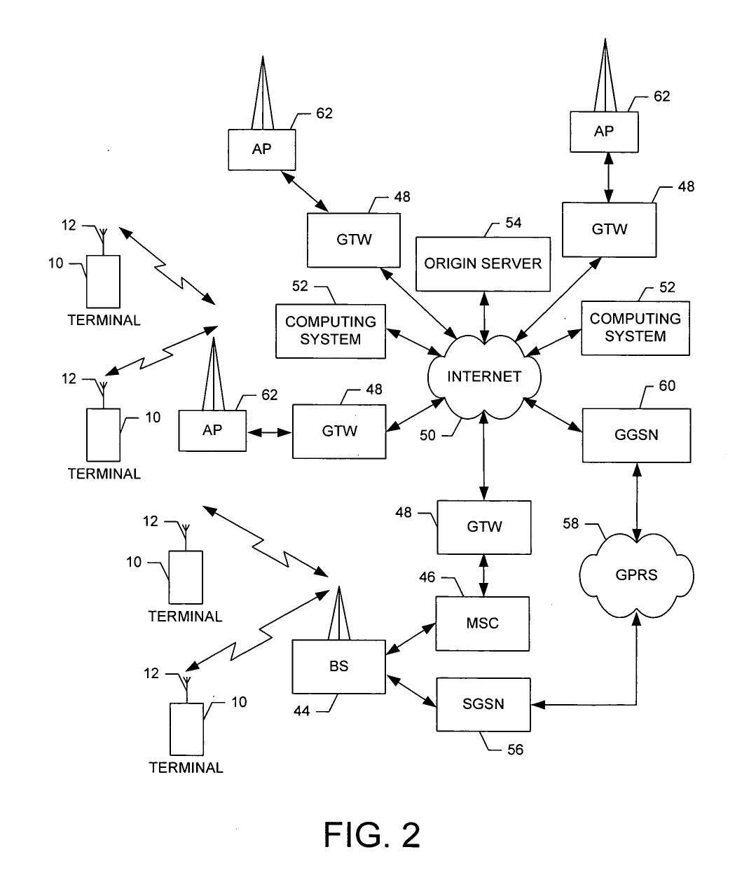

Referring now to FIG. 2, an illustration of one type of system that would benefit from the present invention is provided. As shown, one or more mobile terminals 10 may each include an antenna 12 for transmitting signals to and for receiving signals from a base site or base station (BS) 44. In an exemplary embodiment, one of the mobile terminals 10 may be a third party mobile terminal, as discussed below. The base station 44 is a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as multimedia messages (MMS). The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.1 la, 802.1 lb, 802.11 g, 802.11 n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

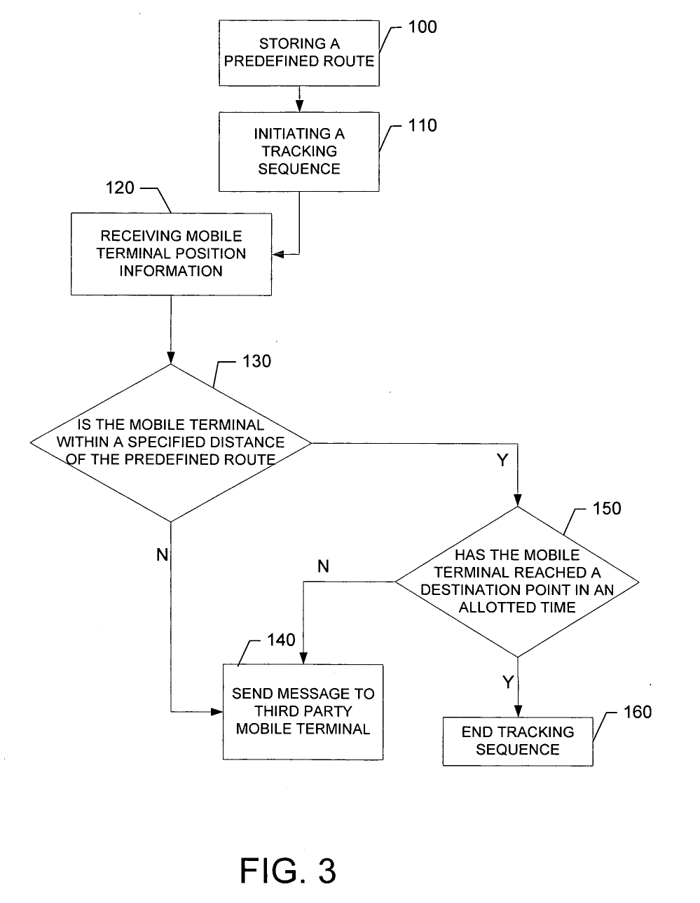

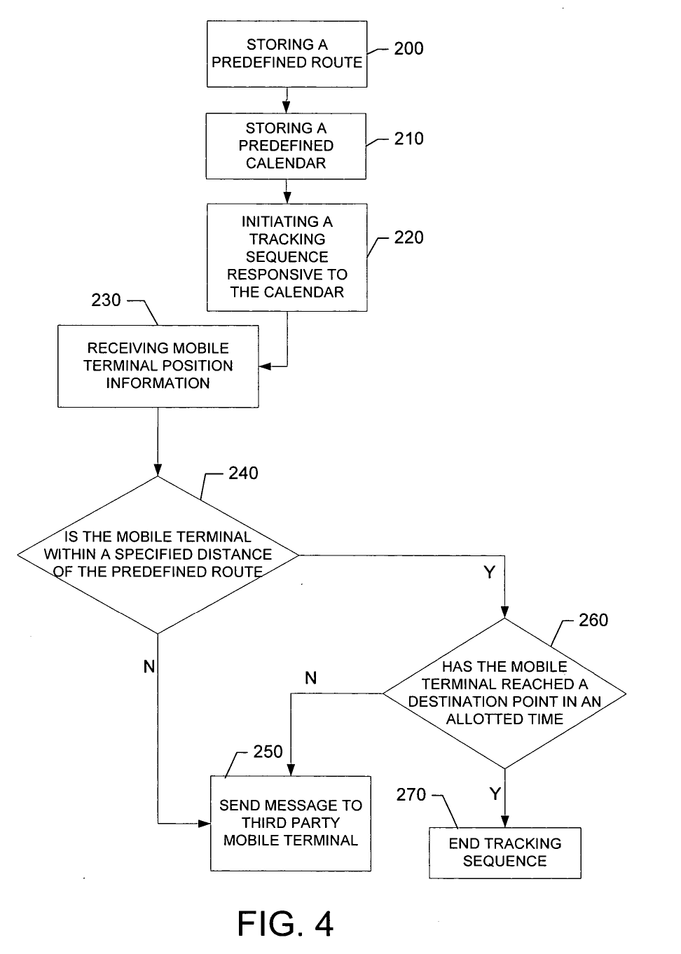

FIGS. 3 and 4 are flowcharts of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal 10, and executed by the controller 20. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, FIG. 3 illustrates one embodiment of a method for providing a mobile school trip guard which includes storing a predefined route at operation 100. The predefined route may be stored in any of the memories of the mobile terminal 10. A user of the mobile terminal 10 may enter the predefined route into any of the memories via a user interface such as, for example, the keypad 30 in conjunction with the display 28. In doing so, the user may, for example, select first and second locations, such as start and destination points, and rely on a route determination made by a related application, such as MapQuest™ or the like, or input a specific route between the start point and the destination. The predefined route may include a list of expected cell ids that will be encountered in route between the start and destination. The list of expected cell ids may be developed by traveling the specific route prior to defining the route. Alternatively, the predefined route may be defined in terms of an X and Y coordinate system between the start and destination points. Also, a number of routes may be prestored by the user, a parent or guardian of the user or by another party or entity with the particular route of interest at the moment being selectable by the user via the user interface.

At operation 110, a tracking sequence is initiated. Initiation of the tracking sequence may be triggered either manually or automatically. For example, the user may select initiation of the tracking sequence via the user interface. Alternatively, the tracking sequence may initiated automatically in response to time or motion triggers. In an exemplary embodiment, the destination and start points may be either a home location or school location. Accordingly, the tracking sequence may be initiated in response to the mobile terminal 10 leaving a cell that is associated with or otherwise services either the home location or the school location.

Following initiation of the tracking sequence, position information is received from the positioning sensor 36 and/or a cell id application operated by the controller 20 of the mobile terminal 10 at operation 120. Examples of means for obtaining position information may be similar to those described in commonly assigned U.S. Pat. No. 6,526,267 entitled Home Area Detection, which issued on Feb. 25, 2003, and U.S. Patent Application Publication No. 2004/0266409 entitled Customisation of an Electronic Device, which published on Dec. 30, 2005, both of which are incorporated herein by reference. In an exemplary embodiment, the position information is provided by a terminal location API (application program interface). Using the position information, a position of the mobile terminal 10 may be tracked by the mobile terminal, such as the controller. Such tracking may include, for example, either continuous reporting of the position information or reporting of the position information at various intervals which may be randomly or manually selected. The position information may include a coordinate location defined in terms of the X and Y coordinate system (such as the latitude and longitude information provided by an inertial system), a cell id (such as that provided by a cell id application), a combination of the two, or another suitable means.

At operation 120, a determination is made as to whether the mobile terminal 10 is within a specified distance from the predefined route. Such determination may be made, for example, by comparing the position information to the predefined route and calculating a difference that is then compared to a threshold. In response to the difference calculated being greater than the threshold, the mobile terminal 10 is determined to be outside of the specified distance from the predefined route. Alternatively, the determination may be made by comparing the current cell id to a list of known or expected cell ids for the predefined route. Furthermore, an order in which specific cell ids should be encountered on a specific predefined route may be stored to determine the expected cell ids. In response to a determination that the mobile terminal 10 is not within the specified distance of the predetermined route, the mobile terminal 10 may issue a message to a third party mobile terminal or other device at operation 140. The message may be embodied in a short message service (SMS) message simply indicating to the third party mobile terminal that the mobile terminal 10 is not within the specified distance of the predetermined route. Alternatively, the SMS message may include an alarm or further information explaining why the message was provided. For example, the SMS message may indicate that an unknown or unexpected cell id was encountered. As another alternative, the message may be embodied in a smart connection between the mobile terminal 10 and the third party mobile terminal. For example, the smart connection may include an automatic phone call connection between the mobile terminal 10 and the third party mobile terminal.

In response to the mobile terminal 10 being determined to be within the specified distance of the predefined route, a determination may be made as to whether the mobile terminal 10 has reached the destination point within an allotted time at operation 150. The allotted time may be pre-selected when the predefined route is stored. Alternatively, the allotted time may be calculated based on a distance between the destination and start points and an average rate of travel depending upon the mode of travel, such as walking, riding a bicycle, etc. In response to the mobile terminal 10 failing to reach the destination point within the allotted time, the message to the third party mobile station may be issued as described above. Furthermore, if the message is embodied as the SMS message explaining why the message was provided, the SMS message may further indicate that the message is the result of the mobile terminal 10 failing to reach the destination point within the allotted time. If the mobile terminal 10 reaches the destination point within the allotted time, the tracking sequence is secured at operation 160.

FIG. 4 shows another embodiment of a method for providing a mobile school trip guard which is substantially similar to the exemplary embodiment described above with reference to FIG. 3 except that a calendar application is incorporated. In this regard, the method includes storing a predefined route at operation 200. The method further includes storing a predefined calendar at operation 210. The predefined calendar may include specific calendar data including dates and times at which corresponding specific predefined routes are to be tracked. Thus, the predefined calendar may, for example, assign a first predefined route to be tracked between two specific points and times on a first day, and assign a second predefined route to be tracked between two different specific points and times on a second day.

At operation 220, a tracking sequence is initiated responsive to the calendar. Accordingly, the tracking sequence for the predefined route assigned to a particular date and time may initiate automatically in response to reaching the time set for the particular date. Thus, in an exemplary embodiment, a child may be tracked from home to school in the morning, from school to an athletic competition in the afternoon, and from the athletic competition to home in the evening without further intervention. Furthermore, the child may be tracked along different routes on different days, all of which are predefined for a corresponding date and time.

Following initiation of the tracking sequence, position information is received from the positioning sensor 36 and/or a cell id application operated by the controller 20 of the mobile terminal 10 at operation 230. Using the position information, a position of the mobile terminal 10 may be tracked as described above. At operation 240, a determination is made as to whether the mobile terminal 10 is within a specified distance from the predefined route. In response to determination that the mobile terminal 10 is not within the specified distance of the predetermined route, the mobile terminal 10 may issue a message to a third party mobile terminal or other device at operation 250. The alarm may be embodied as described above. In response to the mobile terminal 10 being determined to be within the specified distance of the predefined route, a determination may be made as to whether the mobile terminal 10 has reached the destination point within an allotted time at operation 260. In response to the mobile terminal 10 failing to reach the destination point within the allotted time, the alarm to the third party mobile station may be issued at operation 250. If the mobile terminal 10 reaches the destination point within the allotted time, the tracking sequence is secured at operation 270.

It should be noted that although FIGS. 3 and 4 each show both a determination as to whether the mobile terminal 10 is within a specified distance of the predefined route and a determination as to whether the mobile terminal 10 has reached the destination point within an allotted time, either of these operations may be eliminated if desired.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A mobile terminal capable of tracking a position of the mobile terminal between a first location and a second location, the mobile terminal comprising:
a memory for storing executable instructions and route parameters between the first and second locations;
a controller for controlling operation of the mobile terminal and executing the executable instructions; and
a positioning sensor for determining position data of the mobile terminal,
wherein the controller executes instructions for tracking the mobile terminal position data relative to the route parameters, and for directing transmission of a message to another device in response to the tracked position of the mobile terminal differing from the route parameters by a specified amount.

2. The mobile terminal of claim 1, wherein the route parameters include at least one of:
a predefined route between the first and second locations; and
an allotted time to travel between the first and second locations.

3. The mobile terminal of claim 2, wherein the memory stores predefined calendar data including a date and time associated with the predefined route.

4. The mobile terminal of claim 3, wherein the memory stores a plurality of predefined routes and each of the predefined routes is associated with a specific predefined calendar data.

5. The mobile terminal of claim 3, wherein the mobile terminal is configured to automatically initiate tracking responsive to the predefined calendar data.

6. The mobile terminal of claim 1, wherein the mobile terminal is configured to automatically initiate tracking responsive to a change in location of the mobile terminal relative to the first location.

7. The mobile terminal of claim 1, wherein the positioning sensor comprises at least one of:
a pedometer;
an inertial sensor; and
a cell id application.

8. The mobile terminal of claim 1, wherein the message comprises a short message service message.

9. A method for tracking a mobile terminal between a first location and a second location, the method comprising:
initiating a tracking sequence to track the mobile terminal;
receiving position information of the mobile terminal;
determining, responsive to the position information, at least one of whether the mobile terminal is within a specified distance of the predefined route and whether the mobile terminal reaches the second location within an allotted time.

10. The method of claim 9, further comprising storing a predefined calendar in the mobile terminal, the predefined calendar including a date and time associated with the predefined route.

11. The method of claim 10, wherein the initiating the tracking sequence comprises automatic initiation of the tracking sequence responsive to the date and time associated with the predefined route.

12. The method of claim 9, wherein the initiating the tracking sequence comprises automatic initiation of the tracking sequence responsive to a movement of the mobile terminal away from the first location.

13. The method of claim 9, further comprising sending a message to another device in response to the mobile terminal failing to be one of:
within the specified distance of the predefined route; and
at the second location within the allotted time.

14. The method of claim 9, wherein the determining whether the mobile terminal is within the specified distance of the predefined route comprises comparing a current cell id to an expected cell id of the predefined route.

15. A computer program product for tracking a mobile terminal between a first location and a second location, the computer program product comprising at least one computer-readable storage medium having computer-readable program code portions stored therein, the computer-readable program code portions comprising:
a first executable portion for initiating a tracking sequence to track the mobile terminal;
a second executable portion for receiving position information of the mobile terminal;
a third executable portion for determining, responsive to the position information, at least one of whether the mobile terminal is within a specified distance of the predefined route and whether the mobile terminal reaches the second location within an allotted time.

16. The computer program product of claim 15, further comprising a fourth executable portion for storing a predefined calendar, the predefined calendar including a date and time associated with the predefined route.

17. The computer program product of claim 16, wherein the first executable portion comprises a code portion for automatic initiation of the tracking sequence responsive to the date and time associated with the predefined route.

18. The computer program product of claim 15, wherein the first executable portion comprises a code portion for automatic initiation of the tracking sequence responsive to a movement of the mobile terminal away from the first location.

19. The computer program product of claim 15, further comprising a fourth executable portion for sending a message to another device in response to the mobile terminal failing to be one of:
within the specified distance of the predefined route; and
at the second location within the allotted time.

20. The computer program product of claim 15, wherein the third executable portion comprises a code portion for comparing a current cell id to an expected cell id of the predefined route.

21. A system for tracking position of a mobile terminal between a first location and a second location, the system comprising:
a network;
a mobile terminal capable of wireless communication with the network, the mobile terminal configured to store route parameters between the first and second locations and track a position of the mobile terminal relative to the route parameters; and
a device capable of communication with the network,
wherein the mobile terminal is configured to transmit a message to the device in response to the tracked position of the mobile terminal differing from the route parameters by a specified amount.

22. The system of claim 21, wherein the route parameters include at least one of:
a predefined route between the first and second locations; and
an allotted time to travel between the first and second locations.

23. The system of claim 22, wherein the mobile terminal is configured to store predefined calendar data including a date and time associated with the predefined route.

24. The system of claim 23, wherein the mobile terminal is configured to store a plurality of predefined routes and each of the predefined routes is associated with respective predefined calendar data.

25. The system of claim 23, wherein the mobile terminal is configured to automatically initiate tracking responsive to the predefined calendar data.

26. The system of claim 21, wherein the mobile terminal is configured to automatically initiate tracking responsive to a change in location of the mobile terminal relative to the first location.

27. The system of claim 21, wherein the mobile terminal is configured to track the position of the mobile terminal using at least one of:
a pedometer;
an inertial sensor; and
a cell id application.

28. The system of claim 21, wherein the message comprises a short message service (SMS) message.
